(19) United States
(12) Patent Application Publication
(10) Pub. No.: US 2017/0340955 A1
(43) Pub. Date: Nov. 30, 2017

(54) THERMALLY IMAGEABLE SUBSTRATE WITH ENCAPSULATED COREACTANT

(71) Applicant: APPVION, INC., Appleton, WI (US)

(72) Inventor: Michael Gerald COVE, Sherwood, WI (US)

(21) Appl. No.: 15/163,129

(22) Filed: May 24, 2016

(51) Int. Cl. A63F 3/06; B41J 2/32; B41J 2/525

(52) U.S. Cl. CPC A63F 3/0665; B41J 2/525; A63F 3/0685; B41J 2/32

(57) ABSTRACT

A substrate thermal sensitive system for creating a latent image that is useful as a scratch-off ticket that comprises a substrate and a first layer that is superimposed on the substrate. The first layer contains a plurality of microcapsules with a dye precursor or a solvent. The microcapsules are configured to rupture from pressure. The substrate thermal sensitive system further has an acidic developer layer coated over the first layer and containing a co-reactant. Particles of the co-reactant are coated with a meltable material, which is configured to melt when the heat is applied. The system further may include a scratch-off layer coated over the acidic developer layer. The system is configured such that when the meltable material is melted by the thermal printing device and the microcapsules are ruptured, the co-reactant of acidic developer layer reacts with the dye or the solvent of the first layer to develop color.

### BACKGROUND OF THE INVENTION

### Field of the Invention

This invention relates to thermally imageable substrates with encapsulated co-reactant. In particular, thermally imageable substrates that are useful for secure point of sale imaging in diverse applications such as mailers, sweepstakes contest awards, promotional game cards and scratch-off lottery tickets.

### Description of the Background Art

A variety of constructions of substrates containing hidden images such as mailers, sweepstakes contest awards, promotional game cards and scratch-off lottery tickets are known. For example, U.S. Pat. No. 6,308,991 describes a lottery ticket with an authentication feature of a bar code covered by a scratch-off layer. The ticket indicia is pre-printed and covered by a scratch-off layer to obscure the pre-printed indicia.

U.S. Pat. No. 4,726,608 discloses use of an opaque coating over hidden indicia. The indicia subsequently becomes visible by scratching off the opaque coating or by applying a solvent to dissolve the coating.

In an alternative to the aforementioned ticket designs, pull tabs ticket systems are used to cover pre-printed indicia. Examples of such systems are taught in U.S. Pat. Nos. 6,390,916 and 6,379,742.

A typical secure scratch-off system is manufactured by preprinting hidden indicia containing applicable information and/or data onto a substrate which is then concealed by an over layer of an opaque and scratchable coatings. This over layer conceals the gaming data until a consumer scratches the surface with a sharp instrument or coin which rubs off the opaque coating to reveal the preprinted information and/or data.

This method of preprinting information on tickets creates several major issues that are widespread in the ticket manufacturing industry.

Printing presses are available that can create random numbers (or graphics) onto a substrate such as a card stock. The printing operation will typically create a set of randomized cards (the game pieces) in large quantities as the non-winning cards. The printing press will then print a run of winning numbers as winning tickets. The gaming operator will then dose the ticket population with winning tickets to meet the requirements of target gaming “odds”, or any other “odds” that are may be desirable.

This “dosing” process is problematic as it potentially provides for opportunities to “fix” the game by individuals “dosing” to their advantage. This is a potential security risk for the gaming operation.

When all tickets for a game are preprinted, the inventory has a game value only until the winning ticket has been identified and won. Once the buying population recognizes that a winner has been found, the remaining gaming pieces are redundant and must be discarded as a waste.

In other gaming structures the ticket indicia might be randomly generated and a subsequent random winning selection that is made by the gaming provider to offset dosing issues. In this case, redundant tickets are still remaining after the game cycle is complete.

Because the tickets are preprinted, the supply chain from printer to sales outlet must be secure to provide for a proper “chain of custody” in order to prevent unauthorized use or sale of tickets and to prevent fraudulent use.

Accordingly, a need exists for printing hidden indicia containing applicable information and data to a substrate at the point of sale to minimize the need or extent of preprinting required in order to alleviate “chain of custody” concerns, reduce waste, add versatility to gaming systems and enhance security.

A partial solution to the issues that are described above has been print-on-demand gaming systems that are able to generate a gaming ticket at the point of sale. This way, there are no excess tickets generated or wasted inventory that has to be destroyed when the game cycle ends. In addition, there is no need for winning ticket “dosing” process, thereby the system security is greatly enhanced.

An example of such print-on-demand gaming system is an online lottery ticket system. However, such print-on-demand gaming system provides a partial solution only in instances when the game is an instant-win style game. In other words, the game that does not require hidden indicia that contains information and/or data that needs to be undisclosed at the point of sale. Better solutions are needed.

There have been many attempts to use direct thermal printing as the mechanism to create print-on-demand scratch-off gaming tickets as a solution to the aforementioned issues. Generally, the constructions of such print-on-demand scratch-off gaming tickets are very similar in design. It is desirable to image a thermally sensitive material held within the gaming ticket, yet keeping the information hidden from the player.

A conventional thermal ticket has, in at least a single layer—a thermally sensitive imaging layer, a color forming dye (reactant); and acidic developer material (co-reactant) and a low melting point waxy component known as the modifier. This layer is contained within at least two opaque layers, which prevent the player or a reading device from seeing the thermal layer once it has been imaged with a heating device such as a printhead of a thermal printer. The upper layer, which can be coated directly onto the thermally sensitive imaging layer, is usually a rubber based opaque scratch-off layer. The conventional designs are such that the upper layer is easily removed to reveal the gaming data and/or information, such as numbers or graphics, imaged by the thermal device onto the thermally sensitive imaging layer.

For example, U.S. Pat. No. 4,677,553 teaches a scratch-off opaque overlay responsive to thermal printing to print confidential information into a concealed area. Scratch-off ink of Electronek in Carlstradt, N.J. is taught as the scratch-off material.

U.S. Pat. No. 5,431,452 is drawn to a hidden entry system comprising a color developer, formed into a colorless ink, and printed on a surface of a document to form numerals, and a paper substrate with two surfaces. One surface includes a coated color reactant. On the other surface there is a coated pressure sensitive adhesive. The user is required to peel off the color reactant and rub it on the colorless ink to expose the numerals.

Another design variation for instant tickets is pull-tab design. The gaming pieces are revealed by removing a hiding layer, often a laminated card, by pulling it and tearing perforations.

Current thermally imaged, print on demand, instant scratch-off tickets have limitations due to their constructions. Examples of these limitations and drawbacks include:
a) The opaque upper scratch-off layer needs to be of a certain thickness in order to hide the imaged thermally sensitive imaging layer below. This prevents the heat from the thermal printer penetrating down into the imaging layer and creating a difficulty in matching the opacity needed to hide the image, with the energy required to image the layer.
b) A simple solution would seem to be to increase the energy on the thermal printhead. However, this often results in a “ghost” image being created on the opaque layer due to the heat deformations caused by the printhead. This ghosted image is a replica of the hidden thermal gaming data and renders this solution non-operable because the player can see the data as a faint image on the ticket surface.
c) Reducing energy to overcome this issue usually results in insufficient energy to create the thermal imaged gaming ticket.
d) Similarly, constructions have been devised to image the thermal coatings from the backside of the ticket using metallized opaque layers. Again, it has been difficult to prevent the formation of a surface image that cannot be seen by the player prior to the scratch-off process.
e) Other attempted solutions have involved a multistep process whereby the thermally imaged coatings are imaged in the normal way and the thermally coated stock is laminated to an opaque material as a second step in the process.

All the above solutions, incorporating direct thermal imaging technologies, rely on the formation of the thermal image at the time of the printing of the print-on-demand gaming ticket, where the gaming data is subsequently revealed by the player.

### SUMMARY OF THE INVENTION

A substrate thermal sensitive system for creating a latent image useful as a scratch-off ticket comprises a substrate and a first layer that is superimposed on the substrate. The first layer comprises a plurality of microcapsules containing a dye precursor or a solvent. The microcapsules are configured to rupture from pressure. The substrate thermal sensitive system further comprises an acidic developer layer coated over the first layer and contains a co-reactant. The particles of the co-reactant are coated with a meltable material, which is configured to melt when heat is applied from a printing means. The substrate thermal sensitive system may also include a scratch-off top layer coated over the acidic developer layer. The substrate thermal sensitive system is configured such that when the meltable material is heated by the printing means and the microcapsules are ruptured as a result of pressure applied by a user to the top scratch-off layer, the co-reactant of acidic developer layer reacts with the dye or the solvent of the first layer to develop color. “Coated over” is intended to include coating over an intervening layer.

The term “co-reactant” is used to indicate the material which reacts with the colorless reactant (e.g. dye precursor or a solvent) to convert the latent image into a visible image.

The substrate can be selected from paper, film, cardboard, and the like.

The dye precursor can be leuco or fluoran color former.

The meltable material that coats co-reactant particles can be a wax or a stearamide of paraffin wax or a low melt point solid or gel, melting or liquefying at a temperature that can be applied from a thermal printhead or laser imaging devise.

In another embodiment of the invention, the pressure sensitive latent image ticket comprises a substrate and a first layer. The first layer contains a plurality of pressure-sensitive microcapsules with a dye precursor or a solvent. The pressure sensitive latent image ticket further comprises a second acidic developer layer coated over the first layer and contains a plurality of particles of a co-reactant. The particles of the co-reactant are coated with a meltable material or a meltable interlayer exists between the first layer and the second layer wherein the second layer consists of mostly particles of co-reactant. The pressure sensitive latent image ticket further comprises a third layer coated over the second acidic developer layer.

In yet another embodiment, the third layer is selected from a scratch-off layer, a transparent layer, a translucent layer, or a protective top coat layer.

In yet another embodiment, any of the layers coated on the substrate can be coated on only a portion of the substrate that is, typically, paper or film.

The pressure sensitive latent image recording ticket can include, in addition, a scratch-off layer as a top layer or as a layer coated over the second acidic developer layer.

This disclosure also includes a method of recording latent information comprising providing a substrate thermal sensitive system. The system comprising a substrate, a first layer containing a plurality of microcapsules with a dye precursor or a solvent. The microcapsules are configured to being pressure sensitive. The system also provides for an acidic developer layer coated over the first layer and containing a co-reactant. The particles of the co-reactant are coated with a meltable material. A scratch-off layer is coated over the acidic developer layer. The method of recording latent information further comprises recording non-visible information by selective application of heat to the substrate assembly using a printing means.

The method can include the additional step of revealing the recorded non-visible information such as a lottery result by removing the scratch-off layer, typically an opaque overlay, using applied pressure thereby rupturing the microcapsules enabling the dye precursor to contact the acidic developer material and form a visible color in the discrete area where a meltable material coating the particles of the co-reactant was melted by application of heat using a thermal printhead or laser.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

FIG. 1 is a representation of a scratch-off ticket construction showing an acidic developer layer with coated co-reactant and a pressure-sensitive capsulated dye layer according to the invention; and

FIG. 2 is a representation of a scratch-off ticket construction according to the invention.

### DETAILED DESCRIPTION

Exemplary embodiments of the invention will be described in detail below with use of the figures, as applicable.

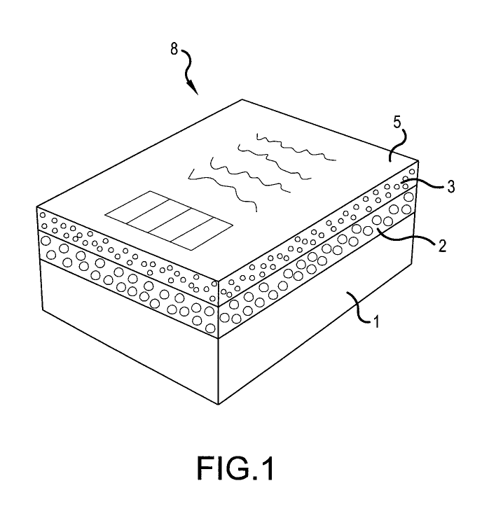

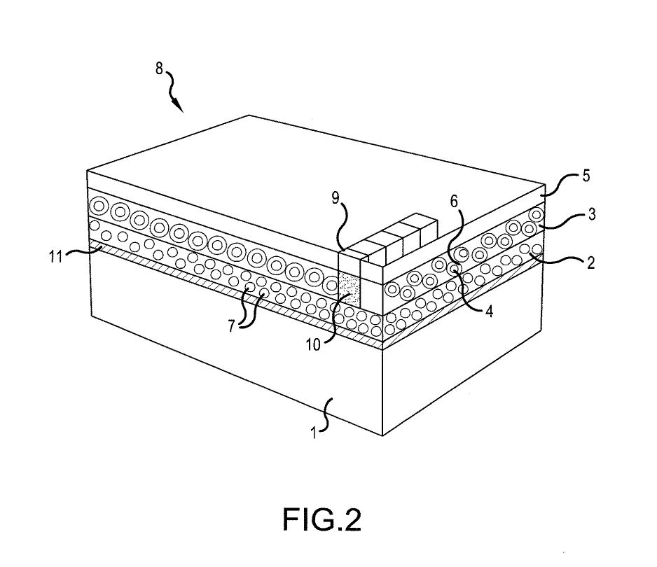

Referring to the drawings, FIG. 1 and FIG. 2 illustrate a substrate thermal sensitive system (8) useful as a scratch-off ticket. In the embodiment illustrated in FIG. 1, the system comprises the four layers, namely, the substrate (1), the electron donor layer (2) that is coated over the substrate (1), the acidic developer layer (3) residing immediately over the electron donor layer (2), and the top layer (5).

As illustrated in FIG. 2, the electron donor layer (2) includes the pressure sensitive microcapsules (7) which contain electron donor material. The acidic developer layer (3) contains the co-reactant (4), the particles of which are covered by meltable material (6).

In the embodiment illustrated in FIG. 2, a printing means can be used to melt the meltable material (6) covering the particles of co-reactant (4) distributed within the acidic developer layer (3), thereby activating colorless acid donor sites within the acidic developer layer (3). When the pressure is applied by scratching off the top layer (5), the pressure sensitive microcapsules (7) contained within the electron donor layer (2) rupture, releasing the internal phase electron donor material that generates a color image when it reacts with the acid donor sites (that are activated by the printing means) of the acidic developer layer (3). The color image is thereby developed specifically where the co-reactant was previously activated (i.e. the meltable material is melted from the co-reactant particles) by the printing means.

The printing means can be a thermal printhead or a laser for applying heat to the meltable material (6).

The internal phase electron donor material of the electron donor layer (2) can be a chromogen such as a leuco dye material and solvent that is able to react with acidic donor sites.

The thermally created imaging step to activate the acid donor sites produces an invisible colorless “image” or precursor to the image and therefore does not require a highly opaque top layer (5), allowing a very thin top layer (5) to be applied without interfering with the energy transfer from the thermal printhead to the acidic developer layer (3). Printing means, for example, for direct thermal papers are thermal printheads. Ideally, the substrate (1) can be used with conventional thermal printheads and laser printheads, therefore allowing the existing base printers and printing means to be used for purposes of applying heat to the meltable material (6) covering the particles of co-reactant (4) of acidic developer layer (3).

In the embodiment illustrated in FIG. 2, the thermal imaging head (9) consists of an array of micro-heaters called a “mesa”. When electrical energy is applied to the heated mesa it causes a rapid increase in temperature which is transmitted to the top layer (5), of the system (8) due to the intimate contact of the mesa and the top layer (5). In the heated area, heat is transferred through the thin top layer (5) causing the meltable material (6) to melt and flow becoming melted material area (10).

According to another embodiment, the design of the acidic developer layer is such that it contains paper pigment materials that absorb the meltable material (6) as it melts to expose the acid donor sites in the acidic developer layer (3).

Typically, oil absorbent paper coating materials such as silicas, aluminum trihydrate, calcined clays and similar materials can be used.

According to yet another embodiment of the present invention illustrated in FIG. 2, an optional primer layer (11) can be employed between the substrate (1) and the electron donor layer (2). The primer layer can be a binder material to aid in adhesion of the electron donor layer (2) to the substrate (1).

Microcapsules (7) cam be dispersed in any of layers (2), (3) or (5), or optionally, even in layer (1).

The thermal mesa array creates a latent image at the interface between the top layer (5) and the acid donor layer (3) through the digital addressing of the thermal mesa as the system advances past the thermal head in much the same way as conventional thermal printing operates. The major advance of the invention is that the latent image is colorless and is present as exposed acidic developer material, i.e., acid donor sites. The acid donor sites are “activated” by the selective application of heat creating the latent image in the melted areas.

This first step in imaging would be conducted by the ticket issuing machine. Digital information delivered to the thermal printhead could come from a host networked system, similar to that used to generate lottery numbers in a state lottery ticket issuing machine or another stand-alone gaming machine.

In either case, the scratch-off ticket according to the present invention is issued to a player containing the gaming information (numbers, graphics, symbols etc.) imprinted invisibly in the ticket.

The player would then scratch off the upper layer (top layer (5)), using, for example, a coin or finger-nail, removing fully or partially the top layer (5) and in the same instance rupturing the pressure sensitive microcapsules (7) and releasing the internal phase containing the dye precursor and/or solvent. This dye precursor and/or solvent is then absorbed by the acidic developer layer (3) creating a color reaction between the acidic developer materials and the dye precursor (i.e. color former) to develop a dark coloration in the acid donor sites positions of the latent image created by the thermal printhead.

Materials that can be used in the invention are typically those used for the manufacturing of thermal papers. Acidic developer materials can be bisphenolic products and other organic acids, described in more detail herein. The color formers used are similar to those used in the production of carbonless or direct thermal papers such as, for example, leuco or fluoran based dye materials.

Solvents used in the microcapsules can be typical solvents and oils used in the design of microcapsules such as carbonless paper production.

Binder materials can be used to create the appropriate rheology for coating and to ensure there is a good cohesion of the coatings and of the key materials at the interface of the coating layers, and as a primer layer. Polymer latexes can be used as the optional primer layer.

In this invention, the meltable material should provide good coverage to the acidic developer particles to prevent any unwanted discoloration through interaction with the scratch-off layer.

According to the embodiment of this invention, the acidic developer particles are coated with a low melting point wax, for example, a stearamide of paraffin wax.

The coating adhesion between the top layer (5) and the acidic developer layer (3) is controlled by the choice of the binders and release ingredients to enable the scratch-off top layer (5) to peel away from the acidic developer layer (3) without disturbing the acidic developer layer (3). A conventional release layer can be interposed between the scratch-off top layer (5) and the acid developer layer (3) that is known in conventional scratch-off tickets.

Typically the scratch-off top layer (5) could contain materials like rubber or lattices which tend to rub off when scratched with an object.

However, in the alternative embodiment, the top layer (5) is colorless and transparent. The top layer is configured to remain intact when scratched with an object. In the same way as described in the previous embodiments of the invention, the internal phase of microcapsule (7) is released to create an image. The image can be then viewed through the transparent top layer (5).

In yet another embodiment, the top layer (5) can be a second sheet similar to a CB sheet of a carbonless form. The second sheet could be applied to the heat activated first sheet such that it is then visibly imaged by applying the second sheet and scratching by an object.

Processes of microencapsulation are well known in the art. The following process can be used to form microcapsules: U.S. Pat. No. 2,730,456 describes a method for capsule formation. Other useful methods for microcapsule manufacture are: U.S. Pat. Nos. 4,001,140; 4,081,376 and 4,089,802 describing a reaction between urea and formaldehyde; U.S. Pat. No. 4,100,103 describing reaction between melamine and formaldehyde; British Pat. No. 2,062,570 describing a process for producing microcapsules having walls produced by polymerization of melamine and formaldehyde in the presence of a styrenesulfonic acid. Microcapsules in a self-contained system are taught in U.S. Pat. Nos. 2,730,457 4,197,346 and 4,873,219. In a self-contained system, microcapsules containing a chromogenic material solution, and an acid developer material, are coated on the same surface of a sheet of paper, and for purposes hereof can be in the same layer or in contiguous layers. Pressure exerted by scratching with an object, such as a coin, or writing or typing causes the microcapsules to rupture and release the chromogenic material, which then reacts with co-reactant or acidic developer to produce color. Other useful processes for forming microcapsules are from urea-formaldehyde resin and/or melamine formaldehyde resin as disclosed in U.S. Pat. Nos. 4,001,140; 4,081,376, 4,089,802; 4,100,103; 4,105,823; 4,444,699 or 4,552,811. Other microencapsulation processes are taught in U.S. Pat. Nos. 6,890,592, 7,122,503, 8,071,214, 8,067,355, 8,067,089, and 7,736,695. The foregoing patents are incorporated herein by reference.

The processes of coating the co-reactant particles with meltable materials are known in the food and pharmaceutical industries. Such processes generally consist of a micro-encapsulation of a solid material. Often the capsules are spray dried. These technologies are designed for delayed release with a heat activated capsule wall material. For example a useful process for forming microcapsules is described in U.S. Pat. No. 8,863,841. The forgoing patent is incorporated herein by reference.

An example of image-forming color formers are colorless electron donating compounds that form color by reacting with an acidic developer material, i.e., co-reactant. Representative examples of such color formers include leuco and substantially colorless compounds having a lactone, a lactam, a sulfone, a spiropyran, an ester or an amido structure in their partial skeleton such as triarylmethane compounds, bisphenylmethane compounds, xanthene compounds, fluorans, thiazine compounds, spiropyran compounds and the like.

In addition to a color former, the microcapsule core material can be selected from solvents such as:
a) dialkyl phthalates in which the alkyl groups thereof have from 4 to 13 carbon atoms, e.g., dibutyl phthalate, dioctylphthalate, dinonyl phthalate and ditridecyl phthalate
b) 2,2,4-trimethyl-1,3-pentanediol diisobutyrate (U.S. Pat. No. 4,027,065)
c) ethyldiphenylmethane (U.S. Pat. No. 3,996,405)
d) alkyl biphenyls such as monoisopropylbiphenyl (U.S. Pat. No. 3,627,581)
e) C.sub.10 C.sub.14 alkyl benzenes such as dodecyl benzene
f) diaryl ethers, di(aralkyl)ethers and aryl aralkyl ethers, ethers such as diphenyl ether, dibenzyl ether and phenyl benzyl ether
g) liquid higher dialkyl ethers (having at least 8 carbon atoms)
h) liquid higher alkyl ketones (having at least 9 carbon atoms)
i) alkyl or aralky benzoates, e.g., benzyl benzoate
j) alkylated naphthalenes
k) partially hydrogenated terphenyls
l) vegetable oils, esters of vegetable oils

If desired, common diluents such as straight chain hydrocarbons can be blended with the solvents, or blend of solvents.

A modifier such as a 1,2-diphenoxyethane can be included in the acidic developer or adjacent layer or layers. Such material typically does not impart any image on its own and is not considered active in the formation of color, but as a relatively low melting solid can act as a solvent to facilitate reaction between mark-forming components. Other such sensitizers are described in U.S. Pat. No. 4,531,140. Other sensitizers, for example, can include N-acetoacetyl-o-toluidine, phenyl-1-hydroxy-2-naphthoate, dibenzyloxalate, para-benzylbiphenyl, and the like.

The color-forming composition comprises color formers such as leuco dye or fluoran color formers in their substantially colorless state and acidic developer material also known as acidic donor material. Chromogenic materials are also known as color formers or dye precursors and the terms are used interchangeably herein. The dye precursors or chromogenic materials react with acidic developer material to express a dye color. The microcapsules can be optionally positioned in any of the acidic developer layer, or any layer adjacent thereto, or even in more than one layer.

The substrate or sheet for purposes hereof is understood to encompass paper and synthetic webs, ribbons, tapes, belts, films, and the like. Cards are preferred. These materials typically have two large surface dimensions and a comparatively small thickness dimension. Each substrate can be appropriately selected to be opaque, optically transparent or translucent or infrared transparent to fit the need or as desired and each could, itself, be colored or not. The material can be fibrous including, for example, paper and filamentous synthetic materials. It can be a film including, for example, cellophane and synthetic polymeric sheets cast, extruded, or otherwise formed.

The imaging color-forming composition chromogenic materials are preferably positioned proximate or adjacent to the developer material layer.

Various layering techniques can be optionally employed to produce a proximate relationship of the color forming composition. In manufacturing, the acidic developer layer, a coating composition can be prepared, and optionally include, a fine dispersion of the components, a binder material typically a polymeric material, surface active agents and other additives in an aqueous coating medium.

In the alternative embodiment, a protective topcoat such as polyvinylalcohol or its derivatives or other binder materials can be optionally utilized in addition to or in place of a scratch-off top layer (5). The meltable material can be a waxy material such as natural waxes such as polyethylene waxes, Carnauba wax, synthetic waxes; and can include lubricants such as zinc stearate; wetting agents; defoamers, and antioxidants.

The various layers applied on the substrate (1) can be applied by coating, printing, flooding, spraying, roll coating, rod coating, gravure, curtain, bill blade, spot printing, offset, air knife and the like.

Coating or layers, for purposes hereof, are intended to encompass any of such application techniques whether coated, printed, laminated or otherwise applied.

In yet another alternative embodiment, the various layers or some of the various layers may optionally be printed or coated onto less than the entire surface of the substrate (1). Such spot printing enables conservation of materials, or could yield a substrate (1) where the coating is active only in a selected area such as a selected pre-printed or pre-coated signature area.

The components of the acidic developer layer are substantially insoluble in the dispersing vehicle (e.g., water) and are ground to an individual average particle size of about 1 micron to about 10 microns, preferably less than 30 microns.

In yet another alternative embodiment, a binder can be included. The binder can be a polymeric material and is substantially vehicle soluble although latexes are also eligible in some instances. The various layers can include binder and latex. Water soluble binders can include polyvinyl alcohol, hydroxy ethylcellulose, methylcellulose, methyl-hydroxypropylcellulose, starch, styrene maleic anhydride salts, modified starches, gelatin and the like. Eligible latex materials include polyacrylates, styrene-butadiene-rubber latexes, polyvinylacetates, polystyrene, and the like. The polymeric binder can be used to protect the coated layers, especially any top layer, from brushing and handling forces occasioned by storage and use of the sheet, card, ticket, or label. Binder should be present in an amount to afford such protection and in an amount less than will interfere with achieving reactive contact between color-forming reactive materials.

Coating weights can effectively be from 0.1 to 9 grams per square meter (gsm), or even from about 3 to about 9 gsm and preferably about 3 to about 6 gsm. The practical amount of coating materials is controlled by economic considerations, functional parameters and desired handling characteristics of the finalized coated substrate.

The color formers can include any conventional chromogens such as phthalide, leucoauramine and fluoran compounds. Other examples of color formers include Crystal Violet Lactone (3,3-bis(4-dimethylaminophenyl)-6-dimethylaminophthalide, U.S. Pat. No. re. 23,024); phenyl-, indolyl, pyrrolyl, and carbazolyl substituted phthalides (for example, in U.S. Pat. Nos. 3,491,111; 3,491,112; 3,491,116; 3,509,174); nitro-, amino-, amido-, sulfonamido-, aminobenzylidene-, halo-, anilino-substituted fluorans (for example, in U.S. Pat. Nos. 3,624,107; 3,627,787; 3,641,011; 3,642,828; 3,681,390); spirodipyrans (U.S. Pat. Nos. 3,775,424 and 3,853,869).

Other specifically eligible color formers which can be used alone or in combination include 3-diethylamino-6-methyl-7-anilino-fluoran (U.S. Pat. No. 3,681,390); 2-anilino-3-methyl-6-dibutylamino-fluoran (U.S. Pat. No. 4,510,513) also known as 3-di-n-butylamino-6-methyl-7-anilino-fluoran; 3-di-n-butylamino-7-(2-chloroanilino)fluoran; 3-(N-ethyl-N-tetrahydrofurfurylamino)-6-methyl-7-3,5′6-tris(dimethylamino)spiro[9H-fluorene-9,1′(3′H)-isobenzofuran]3′-one; 7-(1-ethyl-2-methylindole-3-yl)-7-(4-diethyl-amino-2-ethoxyphenyl)-5,7-dihydrofuro[3,4-b]pyridin-5-one (U.S. Pat. No 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindole-3-yl)-7-(4-diethyl-amino-2-ethoxyphenyl)-5,7-dihydrofuro[3,4-b]pyridin-5-one; 3-diethylamino-7,8-benzofluoran; 3,3-bis(1-ethyl-2-methylindole-3-yl)phthalide; 3-diethylamino-7-anilinofluoran; 3-diethylamino-7-benzylaminofluoran; 3′-phenyl-7-dibenzylamino-2,2′-spirodi-[2H-1-benzopyran] and mixtures of any of the above.

Eligible acidic (or electron accepting) color-developer material include the compounds listed in U.S. Pat. No. 3,539,375 as phenolic reactive material, particularly the monophenols and diphenols. Other eligible acidic developer materials also include, without being considered as limiting, the following compounds which may be used individually or in mixtures: 4,4′-isopropylidine-diphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicylanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; bis(3-allyl-4-hydroxyphenyl) sulfone, 2,2-bis(4-hydroxyphenyl)-4-methylpentane; benzyl-4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl)pentanoate; allyl-4,4-bis(4-hydroxyphenyl)pentanoate; 3,3-bis(4-hydroxyphenyl)-pentane; 4,4-bis(4-hydroxyphenyl)heptane; 2,2-bis(4-hydroxyphenyl)-1-phenylpropane; 2,2-bis(4-hydroxyphenyl)butane; 2,2′-methylene-bis(4-ethyl-6-tertiarybutylphenol); 4-hydroxycoumarin; 7-hydroxy-4-methylcoumarin; 2,2′-methylene-bis(4-octylphenol); 4,4′-sulfonyldiphenol; 4,4′-thiobis(6-tertiarybutyl-m-cresol); methyl-p-hydroxybenzoate; n-propyl-p-hydroxybenzoate; benzyl-p-hydroxybenzoate; 4-(4-(1-methylethoxy)phenyl) sulphonyl phenol. Preferred among these are the phenolic developer compounds. More preferred among the phenol compounds are 4,4′-isopropylidinediphenol, ethyl-4,4-bis(4hydroxyphenyl)pentanoate, n-propyl-4,4-bis(4-hydroxyphenyl) pentanoate, isopropyl-4,4-bis(4-hydroxyphenyl)pentanoate, methyl-4,4-bis(4-hydroxyphenyl)pentanoate, 2,2-bis(4-hydroxyphenyl)-4-methylpentane, p-hydroxybenzophenone, 2,4-dihydroxybenzophenone, 1,1-bis(4-hydroxyphenyl)cyclohexane, and benzyl-p-hydroxybenzoate; 4-(4-(1-methylethoxy)phenyl)sulphonyl phenol and 4,4′-[1,3-phenylenebis(1-methylethylene)]bisphenol. Acidic compounds of other kind and types are eligible. Examples of such other acidic developer compounds are phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, attapulgite, hallosyte, and the like. Some of the polymers and minerals do not melt but undergo color reaction on fusion of the chromogen. Of the foregoing particularly the phenol type of compounds are more preferable acidic developer materials.

The following examples are given to illustrate some of the features of the present invention and should not be considered as limiting. In these examples all parts or proportions are by weight and all measurements are in the metric system, unless otherwise stated.

In all examples illustrating the present invention a dispersion of a particular system component was prepared by milling the component in an aqueous solution of the binder until a particle size of between about 1 micron and 10 microns was achieved. The desired average particle size typically was less than 3 microns in each dispersion.

The coatings (or layers) can be made by making separate dispersions of chromogenic material and acidic material and coating or printing same onto the substrate. The dispersions are mixed in the desired ratios and applied to the substrate with a wire wound rod and dried. Other non-active (as that term is understood in this application) materials such as modifiers, fillers, antioxidants, lubricants and waxes can be added if desired. The substrate may be calendered to improve smoothness.

In the examples of the thermal response of the label stock is checked by imaging with a conventional thermal printer or thermal test instrument like the Atlantek 400 or Zebra Z4M. The color produced can be measured with a Macbeth RD514 densitometer, #106 filter or similar Densitometer. The dispersions are prepared in a quickie mill, attritor and small media mill.

### EXAMPLES

With reference to FIG. 1 and FIG. 2, a recording material according to the invention can be assembled as follows:
a) Substrate: (1) is selected from
   i) a paper substrate with a grammage range of 40-300 g/m2
   ii) possible alternatives for the examples above include coating films biaxially oriented polypropylene or high density polyethylene, in the range 40-300 g/m2
b) Dye precursor layer (the first layer (2)) that is coated over the substrate (1)
c) Layer (3) is coated on the electron donor layer (2) and contains an acid developer particles coated with low melting point meltable material

### Example 1

### Bisphenol A Bisphenol S

d) A meltable material covering the acidic developer particles. The meltable material is meltable in response to the applied heat of a thermal printhead

### Example 2

### Stearamide Wax, Carnauba Wax

e) Layer (5): a scratch-off top layer coated over the layer (3)

### Example 3

Parts By Weight

| | |
|---|---|
| scratch-off ink | 50 parts (e.g., Aquo Print from Spring Coating |
| | Systems) |
| microcapsules (dry) | 20 parts (1-20 μm capsules ) |
| water | |

The scratch-off top layer can also be applied on press as an ink. Suitable scratch-off materials include: Colorcon FGN1691 or Elecktromelt SC2900E (Carlstadt, N.J.). Other suitable scratch-off or rub-off inks include acrylic resin, water and aluminum powder dispersions, for example, G Tech U.S. Pat. No. 5,215,567 incorporated herein by reference.
f) Pressure sensitive microcapsules containing a colorformer and a solvent

### Example 4

Parts By Weight

| | | |
|---|---|---|
| acrylic emulsion (50%) | 200 | parts |
| filler | 5-30 | part |
| capsules (dry) | 5-30 | part |
| water | 10-60 | part (dilute to approx 50% solids) |

Wherein the filler can be 100% calcium carbonate; 100% powdered aluminum metallic or ratios of the two materials. for example 25% calcium carbonate; 75% aluminum.

### Example 5

Capsule Preparation
Internal Phase
Colorformers:

| | |
|---|---|
| 3′chloro-6′-cyclohexylamino-spiro[isobenzofuran-1(3H), | 1.58% |
| 9′-[9H]xanthen]-3-one | |
| 6′-[ethyl(3-methylbutyl)amino]-3′-methyl-2-′(phenylamino)- | 2.50% |
| spiro[isobenzofuran-1(3H), 9′-[9H]xanthen]-3-one | |
| 3-diethylamino-6-methyl-7-(2,4-dimethylphenyl)aminofluouran | 1.11% |

Solvents

| | |
|---|---|
| soybean oil | 26.83% |
| canola oil methyl ester | 39.21% |
| normal paraffinic hydrocarbons (Norpar 12 solvent) | 16.51% |

Aqueous Phase I

| | |
|---|---|
| acrylic Copolymer | 2.11% |
| NaOH | 0.32% |
| melamine-formaldehyde Resin | 1.08% |

Aqueous Phase II

| | |
|---|---|
| acrylic Copolymer | 1.76% |
| 20% NaOH | 0.01% |
| melamine-formaldehyde Resin | 5.93% |

Salt

| | |
|---|---|
| Na₂SO₄ | 1.06% |

### Example 6

Using similar ratios as in the preceding Example, in a jacketed reactor, an acrylic butyl-acrylate copolymer, caustic, and deionized water are combined with heating to about 65° C. while mixing. The target pH for the first aqueous phase is 5.65-5.75. A colorformer, such as 3-diethylamino-6-methyl-7-(2,4-dimethylphenyl)aminofluoran is dissolved in a vegetable oil methyl ester in a jacketed first container at approximately 100° C. A second aqueous phase is prepared by combining acrylic butyl-acrylate copolymer, caustic, and deionized water in a second container. The second aqueous phase is mixed and allowed to sit at room temperature. The target pH for the second aqueous phase is 4.40-4.55. A solvent or mixture of solvents such as a mixture of soybean oil and/or normal paraffinic hydrocarbons are added to the first solution. After the addition, the temperature of the internal phase (IP) is brought to ^{˜}80° C. The IP was is allowed to cool to ^{˜}75° C., at which point melamine formaldehyde resin is then added to the reactor containing the preheated first aqueous phase. Four minutes after the melamine formaldehyde addition, the IP is added to the reactor over ^{˜}8 minutes. After this time, milling is started at 1150 fpm (mill speed can range from 1000 fpm to 1250 fpm, depending on desired capsule size, solvent ratio, solvent type and colorformer amount) and continued for 30 minutes. At the completion of 30 minutes, milling is stopped with agitation continued. An etherified methyol melamine oligomer is then added to the second water phase and allowed to mix for approximately 10 minutes before addition to the reactor. 500 g of Na₂SO₄ is added to the reactor. The batch is allowed to mix with agitation for 8 hours at 65° C., at which point the heat is discontinued. Thereafter, the batch is diluted and neutralized with NH₄OH to pH 7.5-8.25.

Capsule sizes range from 3 μm to 5.8 μm, dependent primarily on milling speed. Canola oil methyl ester can be advantageous to solvate dyes. Soybean oil can be a primary diluent. Normal paraffinic hydrocarbons (Norpar 12, Exxon Mobil, Houston, Tex.) alternatively can be a primary or secondary diluent. Rupture of the capsules would release the encapsulated solvated dyes.

The microcapsules are dispersed in any of layers (1), (2), (3), or (5). The microcapsules can be used at anywhere from a fraction of a percent by weight of the receptive layer or even up to three or even five percent of a layer, or more. Sufficient amount of the microcapsules are employed to yield the desired image, with more or less being employed depending on intensity of the desired image density.

All percentages, parts, and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A substrate thermal sensitive system for creating a latent image useful as a scratch-off ticket comprising:
a substrate;
a first layer superimposed on the substrate containing a plurality of microcapsules with a dye precursor or a solvent, wherein the microcapsules are configured to rupture by pressure;
an acidic developer layer coated over the first layer and containing a co-reactant, wherein a plurality of particles of the co-reactant are coated with a meltable material configured to melt by applying heat from a printing means; and
a scratch-off layer coated over the acidic developer layer,
wherein when the meltable material is heated by the printing means and the microcapsules are ruptured, the co-reactant reacts with the dye or the solvent to develop color.

2. The substrate thermal sensitive system according to claim 1, wherein the substrate is selected from paper or film.

3. The substrate thermal sensitive system according to claim 1, wherein the dye precursor is a leuco or fluoran color former.

4. The substrate thermal sensitive system according to claim 1, wherein the meltable material is selected from a stearamide of paraffin wax, a low melt point solid, or a gel.

5. The thermal sensitive system according to claim 1, wherein the scratch-off top layer material is a rubber or a lattice.

6. The substrate thermal sensitive system according to claim 1, wherein any of the layers coated on the substrate are coated on only a portion of the substrate.

7. The substrate thermal sensitive system according to claim 1, wherein the scratch-off ticket is a lottery ticket.

8. The substrate thermal sensitive system according to claim 1, further comprising an optional primer layer.

9. A pressure sensitive latent image ticket comprising:
a substrate;
a first layer superimposed on the substrate comprising a plurality of microcapsules with a dye precursor or a solvent;
a second acidic developer layer coated over the first layer and containing a plurality of particles of a co-reactant, which are coated with a meltable material; and
a third layer coated over the second acidic developer layer.

10. The pressure sensitive latent image ticket of claim 9, wherein the third layer is selected from a scratch-off layer, a transparent layer, a translucent layer, or a protective top coat layer.

11. The pressure sensitive latent image ticket of claim 9, wherein any of the layers coated on the substrate are coated on only a portion of the substrate.

12. The pressure sensitive latent image ticket of claim 9, wherein the substrate is selected from paper or film.

13. The pressure sensitive latent image ticket of claim 9, further comprising a scratch-off layer as a top layer.

14. A method of recording latent information comprising steps of:
providing a substrate thermal sensitive system comprising:
a substrate;
a first layer superimposed on the substrate containing a plurality of microcapsules with a dye precursor or a solvent, wherein the microcapsules are configured to rupture by pressure;
an acidic developer layer coated over the first layer and containing a co-reactant, wherein a plurality of particles of the co-reactant are coated with a meltable material; and
a scratch-off layer coated over the acidic developer layer,
wherein when the meltable material is heated by the printing means and the microcapsules are ruptured, the co-reactant reacts with the dye or the solvent to develop color; and
recording non-visible information by selective application of heat to the substrate assembly using a printing means, the meltable material melting in discrete areas where heat is applied from the printing means.

15. The method of recording latent information according to claim 14, further including the step of revealing the recorded non-visible information by removing the scratch-off layer using applied pressure thereby rupturing the microcapsules enabling the dye precursor to contact the acidic developer material and form a visible color in the discrete areas where the meltable material melted.

16. The method according to claim 14, wherein recording the latent information is by a selective application of heat from a printing means comprising a thermal printhead or laser.

17. The method according to claim 14, wherein the scratch-off layer is an opaque overlay disposed over the acidic developer layer.

18. The method according to claim 14, wherein the recording of latent information comprises recording of a lottery result.
